(19) United States
(12) Patent Application Publication
(10) Pub. No.: US 2023/0195068 A1
(43) Pub. Date: Jun. 22, 2023

(54) Portable device assisted commissioning of a drive

(71) Applicant: Danfoss Power Electronics A/S, Gråsten (DK)

(72) Inventor: Søren Bækhøj Kjær, Harrislee (DE)

(21) Appl. No.: 18/067,898

(22) Filed: Dec. 19, 2022

(30) Foreign Application Priority Data
Dec. 20, 2021 (DE) 102021133890.5

(51) Int. Cl. G05B 19/042

(52) U.S. Cl. CPC G05B 19/0426; G05B 2219/2609; H04M 1/72409

(57) ABSTRACT

The present invention pertains to a method for commissioning an electric motor drive application (4), wherein the drive application (4) has an electric motor drive (2) and an electric motor (3), the method having the steps of performing a measurement at or near the application (4) by means of a smartphone (1); transferring the measured data from the smartphone (1) to the drive (2); and adjusting the settings of the drive (2) in dependence on the measured data. The invention also pertains to an electric motor drive (2), having wireless connection means (21) for connecting the drive (2) to a smartphone (1). The electric motor drive is provided for performing the method according to any of claims 1 to 9.

### CROSS-REFERENCE TO RELATED APPLICATION

This application claims foreign priority benefits under 35 U.S.C. § 119 from German Patent Application No. 102021133890.5, filed Dec. 20, 2021, the content of which is hereby incorporated by reference in its entirety.

### TECHNICAL FIELD

The present invention pertains to a method for commissioning an electric motor drive application,

wherein the drive application comprises an electric motor drive and an electric motor, the method comprising the steps of
performing a measurement at or near the application by means of a smartphone;
transferring the measured data from the smartphone to the drive; and
adjusting the settings of the drive in dependence on the measured data.
   The invention also pertains to an electric motor drive, comprising wireless connection means for connecting the drive to a smartphone. The electric motor drive is provided for performing the method according to any of claims 1 to 9.

### BACKGROUND

Known electric motor drive applications may comprise a plurality of extended functions such as automatic energy optimization (AEO), automatic motor adaption (AMA) and/or a speed controller.

The correct commissioning of the electric motor drive application may increase its overall performance and reduce its energy consumption. In order to achieve these benefits, the electric motor drive applications or rather their functions must be enabled and/or tuned correctly. The correct enabling and/or tuning of the functions may be problematic to a user, as it may require special knowledge and/or special devices such as sensors. It is therefore frequently the case, that known electric motor drive applications are not set to their ideal settings.

### SUMMARY

The aim of the invention is to overcome this problem by providing an improved method for commissioning an electric motor drive application and an improved electric motor drive, which overcome the above-mentioned problem.

This aim is achieved by a method according to claim 1 and an electric motor drive according to claim 10. Preferable embodiments of the invention are subject to the dependent claims.

According to claim 1, a method for commissioning an electric motor drive application is provided. The drive application comprises an electric motor drive and an electric motor. The method comprises the steps of
performing a measurement at or near the application by means of a smartphone;
transferring the measured data from the smartphone to the drive; and
adjusting the settings of the drive in dependence on the measured data.

Smartphone assisted commissioning helps during commissioning of the application. It makes it possible to utilize the integrated sensors in the smartphone. The sensors for the smartphone may provide additional feedback from the drive, the motor and/or the entire application during or prior to the commissioning. This feedback may only be needed during setup and/or commissioning of the application. This facilitates the gathering of additional information concerning the application. Said information may then be used to improve the quality and ease of the commissioning. As a result, the motor may be controlled to achieve faster accelerations without compromising system constrains. The application may be run at the optimum setpoint and hereby increase its value for the user.

The term smartphone may be understood in a broad sense and may comprise any electronic computing device such as notepad, laptop, personal computer, in particular a portable personal computer, handheld computer, iPad, pocket PC, etc.

The collected sensor data or the corresponding measurements signals may be pre-processed by the smartphone and may be transmitted back to the electric motor drive. The settings of the drive may then be optimized based on said data and by means of dedicated algorithms.

In a preferred embodiment of the invention, the method comprises utilising at least one integrated sensor of the smartphone and in particular only utilising at least one integrated sensor of the smartphone. The method may be therefore independent of the sensor hardware provided at the drive. The only requirement is that the drive comprises some means for receiving data from the smartphone.

In another preferred embodiment of the invention, a wireless connection is established between the smartphone and the drive. The wireless connection may be a Bluetooth connection or any other connection suitable for transferring data between a smartphone and an electric motor drive.

The wireless connection is not limited to be a Bluetooth connection but may also be an infrared connection (IR) and/or a WIFI (e.g. IEEE 802.11) connection.

In another preferred embodiment of the invention, the measured data is pre-processed in the smartphone prior to its transfer to the drive, and or the smartphone (1) and the drive (2) are time-synchronized. The pre-processing may comprise some or all of the calculation steps required for adjusting the settings of the drive. Once some or all of the calculation steps have been performed by the smartphone, the pre-processed data may then be transferred for the adjustment of its settings. The time-synchronization of the devices allows for correct time-stamping of data and therefore helps improving the quality of the results obtainable according to the method.

In another preferred embodiment of the invention, performing the measurement comprises measuring the air pressure and/or air flow speed at the drive application, in particular by using a barometer and/or an anemometer of the smartphone and/or connected to the smartphone. The sensors may be used in combination with each other or only a single of the sensors may be used. In particular, the sensor or the sensors may be used in a HVAC application.

Various types of sensors may be used in the context of the present invention. A gyroscope may be used for tuning of controllers, e.g. for boom or turntable applications. A microphone may be used for the detection of vibrations. A magnetometer may be used for measurement of speeds.

A GPS sensor may be used for determining the location of the application and therefore its altitude above sea level. As lower cooling capabilities of air may be deduced from the altitude of the application, this information may be used for tuning of a fan speed of the application.

The sensors e.g. an air pressure sensor and/or air flow speed sensor, a barometer and/or anemometer, cameras etc. may not be connected directly to the smartphone but may be interconnected via a hub, router, switch, repeater or similar to support multiple devices/sensors to connect to one or more smartphones.

Temperatures may be measured by temperature sensors sending signals to the drive and the drive sending said temperature signals to the smartphone or the cloud.

In another preferred embodiment the temperatures may be acquired by infrared cameras attached to the smartphone and the temperature data may be sent wirelessly from the smartphone to the drive.

In another preferred embodiment of the invention, performing the measurement comprises measuring the acceleration of the electric motor and/or of mechanical components connected to the electric motor, in particular by using an accelerometer of the smartphone.

In another preferred embodiment of the invention, performing the measurement comprises determining the number of pole-pairs of the motor, in particular by using a slow-motion camera or a magnetometer of the smartphone. The camera may be used to record images of the moving motor and in particular its pole-pairs. The slow-motion camera may be used as a tachometer. The smartphone may comprise software which may automatically determine the number of pole-pairs from the captured images. Alternatively, or additionally, a user of the method may simply count the number of pole-pairs and input the number into the smartphone or into the drive directly.

In another preferred embodiment of the invention, performing the measurement comprises identifying resonances in the application, in particular by using an accelerometer of the smartphone. This may assist in the optimization of the ramp times and the tuning of speed controller of the drive. The resonances may be identified by performing a frequency sweep of the application, wherein the electric motor drive alone or together with the smartphone control the electric motor to run at various speeds within its range of operating speeds. The sensors of the smartphone may be in physical contact with the application such that resonance frequencies of the application and corresponding speeds of the motor, at which said resonance frequencies occur, may be captured or measured by the smartphone. The accelerometer in the smartphone may be used to estimate the frequency of the swinging/sway of the load at different cable lengths of the electric cables used with the application and this information may later on be used to optimize the anti-sway algorithm to mitigate the swinging.

In another preferred embodiment of the invention, adjusting the settings of the drive comprises optimizing the drive by means of dedicated algorithms.

The invention also pertains to an electric motor drive according to claim 10. The electric motor drive comprises wireless connection means for connecting the drive to a smartphone. Furthermore, the drive is provided for performing the presently described method. It may therefore comprise any hardware and/or software components required for performing the method.

### BRIEF DESCRIPTION OF THE DRAWINGS

Further details and advantages of the invention are described with reference to the embodiments shown in the figures. The figures show:

FIG. 1: a schematic presentation of an electric motor drive application commissioned by means of a smartphone;

FIG. 2: a smartphone with app wirelessly commissioning a drive directly;

FIG. 3: a smartphone with app wirelessly commissioning a drive;

FIG. 4: a smartphone with app measuring vibrations on a motor;

FIG. 5: a smartphone acquiring say images or videos of the motor axle; and

FIG. 6: a principal example of the app running on the smartphone.

### DETAILED DESCRIPTION

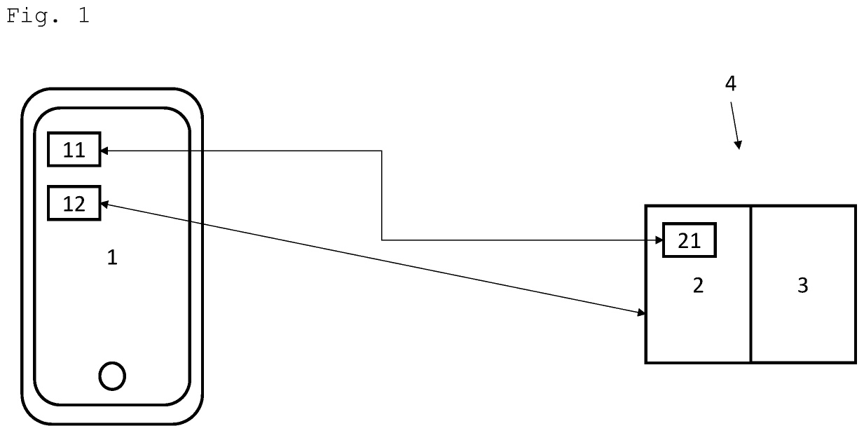

FIG. 1 shows a schematic presentation of an electric motor drive application 4, which is being commissioned by means of a smartphone 1. The drive application 4 comprises an electric motor drive 2 and an electric motor 3. The electric motor drive application 4 comprises wireless connection means 21 for connecting the application 4 to the smartphone 1. The smartphone 1 may comprise some corresponding wireless connection means 11, which are provided for establishing a wireless connection with the electric motor drive application 4. The wireless connection is indicated by the upper arrow in FIG. 1. The wireless connection may be a Bluetooth connection or any other connection suitable for transferring data between a smartphone and an electric motor drive 4.

A sensor 12 of the smartphone 1 may be provided for measuring some physical property of the electric motor drive application 4. Although the sensor 12 is shown to be within the smartphone 1 in FIG. 1, the present invention is by no means limited to sensors 12 integrated with the smartphone 1. For example, an external sensor 12 may be provided, which may be connected to the smartphone 1 and/or the electric motor drive application 4.

The method may be therefore independent of the sensor hardware provided at or with the drive 2. The only requirement is that the drive 2 comprises some means for receiving data from the smartphone 1. Alternatively, the drive 2 may be provided such that communication means for receiving data from the smartphone 1 may easily be connected to the drive's 2 hardware. The measured data may be transferred in some form from the smartphone 1 to the electric motor drive application 4. The data transfer from the smartphone 1 to the electric motor drive application 4 is indicated by the lower arrow in FIG. 1.

The presently described method comprises the step of performing a measurement at or near the application 4 by means of the smartphone 1. The smartphone 1 may be in direct contact with the electric motor drive application 4 or its sensor 12 may be used for measuring physical properties of the electric motor drive application 4 and/or its surrounding while the smartphone 1 is at a distance from the electric motor drive application 4.

The measurements performed by the smartphone 1 may comprise measurements of the air pressure and/or air flow speed at the drive application 4. In particular, the air flow speed of the cooling system and/or of a wind-duct of the electric drive application 4 may be measured. A barometer and/or an anemometer may be integrated with the smartphone 1. Additionally or alternatively, an external barometer and/or an anemometer may be provided close to the electric drive application 4 and may be connected to the smartphone 1. The connection between the smartphone 1 and the electric drive application 4 may be wireless. The sensors may be used in combination with each other or only a single of the sensors may be used during the method. The presently described sensors may be used in a HVAC application.

The sensor may be used for determining the number of pole-pairs of the motor 3. In order to determine the number of pole-pairs of the motor 3, a slow-motion camera of the smartphone 1 may be used. The camera may be used to record images of the moving motor 3 and in particular its pole-pairs. Additionally or alternatively, the slow-motion camera may be used to calculate the speed of the motor shaft.

The smartphone may comprise some image recognition software which may automatically determine the number of pole-pairs from the captured images. Alternatively or additionally, a user of the method may simply count the number of pole-pairs and input the number into the smartphone 1 or into the drive 2 directly.

Using the sensor 12, mechanical resonances in the drive application 4 may be identified. An accelerometer of the smartphone 1 may be used for this purpose. Mechanical resonances of mechanical applications occur at resonance frequencies of the applications and are detrimental to the durability of the applications as well as their overall performance.

The identification of the mechanical resonances may therefore assist in the optimization of the ramp times and the tuning of speed controller of the drive. The resonances may be identified by performing a frequency sweep of the application, wherein the electric motor drive alone or together with the smartphone 1 control the electric motor to run at various speeds within its range of operating speeds. The sensors 12 of the smartphone 1 may be in physical contact with the drive application 4 such that resonance frequencies of the drive application 4 and corresponding speeds of the motor 3, at which said resonance frequencies occur, may be captured or measured by the smartphone 1.

Another step of the presently described method is transferring the measured data from the smartphone 1 to the drive 2. This is indicated by the upper arrow in FIG. 1.

Prior to the data transfer, the measured data may be pre-processed in the smartphone 1. The pre-processing may comprise some or all of the calculation steps required for adjusting the settings of the drive 2. Once some or all of the calculation steps have been performed by the smartphone 1, the pre-processed data may then be transferred for the adjustment of the settings of the drive 2. In order to allow the method to deliver high fidelity results, time-synchronization between the drive 2 and the smartphone 1 may be provided.

Once the data has been transferred from the smartphone 1 to the drive 2, the settings of the drive 2 are adjusted in dependence on the measured data in a further step of the method. Adjusting the settings of the drive 2 may comprise optimizing the drive 2 by means of dedicated algorithms. Such algorithms make it possible to automatically readjust the settings of the drive 2 such that e.g. the energy consumption of the motor 3 is reduced, its output is enhanced and/or the durability of the electric motor drive application 4 or of its components is maximized.

Additionally or alternatively, prior to the adjustment of the drive 2 settings, the smartphone 1 may notify a user of the smartphone 1 and/or the electric motor drive application 4 that an AMA has not been performed on the drive 2 and the system does not operate in its optimal settings. The smartphone 1 may then the output a few suggestions such as 1] to start the AMA in order to improve the efficiency of the electric motor drive application 4, and/or 2] to turn on some specific sensor 12 of the smartphone 1 such as its slow-motion camera. Together with these outputs, the smartphone 1 may output further information such as what benefits in terms of e.g. lifetime extension and/or performance enhancement the suggested steps might yield.

Additionally or alternatively, the smartphone 1 may output information on functions or features of the electric motor drive application 4, which have not been performed or not performed sufficiently by the electric motor drive application 4. These may be features or functions, which a user of the invention has never come across and/or may be newly released features, which have been added to the electric motor drive application 4 after its initial commissioning. Some functions of the electric motor drive application 4 may such as AMA may be enabled as default and may only be turned off by a user if needed.

The electric motor drive 2 of the present invention comprises wireless connection means 21 for connecting the drive 2 to a smartphone 1. The drive 2 is provided for performing the presently described method. It may comprise any hardware and/or software components required for performing the method.

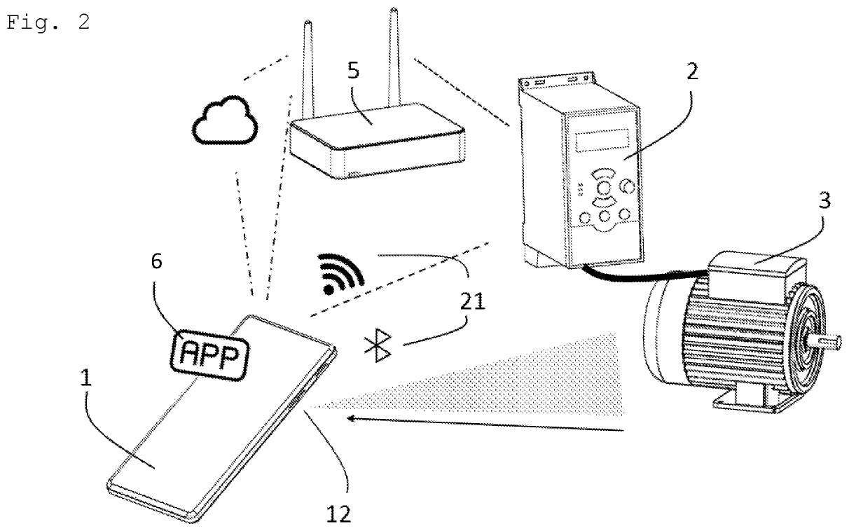

FIG. 2 shows a smartphone 1 with an app 6 for wirelessly commissioning a drive 2 directly as indicated by the dashed line. This can be done via Bluetooth, WiFi, IR 21. Alternatively or additionally, the commissioning can be done indirectly as indicated by the chain line via either a cloud or via a hub 5. The term hub 5 may be understood in a broad sense and may be a router, switch, and/or a repeater, which is typically identified by having ports for input and output wired or wireless data communication in e.g. a network. The hub 5 may not be limited to one unit but may comprise multiple units in serial or parallel networks.

The drive 2 provides power to the motor 3 and the motor 3. During operation of the motor 3, it returns signals such as sound, RPM, images or videos, vibrations, temperature, pressure back to the drive 2 and/or to the smartphone built-in sensors 12.

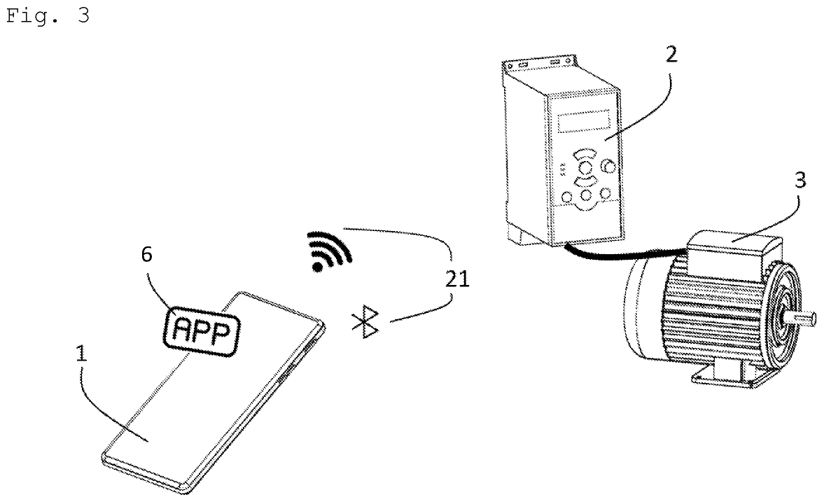

FIG. 3 shows a smartphone 1 with an app 6 wirelessly commissioning the drive 2, the drive 2 providing power to the motor 3 and the motor 3 again returning signals such as sound, RPM, images or videos, vibrations, temperature, pressure, barometric pressure back to the drive 1 and/or the smartphone built-in sensors 12.

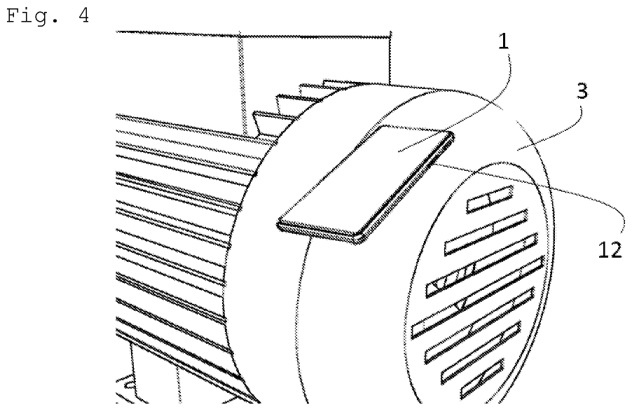

FIG. 4 shows a smartphone 1 with an app 6 measuring vibrations on the motor 3 using the built-in smartphone accelerometer sensor 12. The phone 1 is in direct physical contact with the motor 3 for capturing its vibrations.

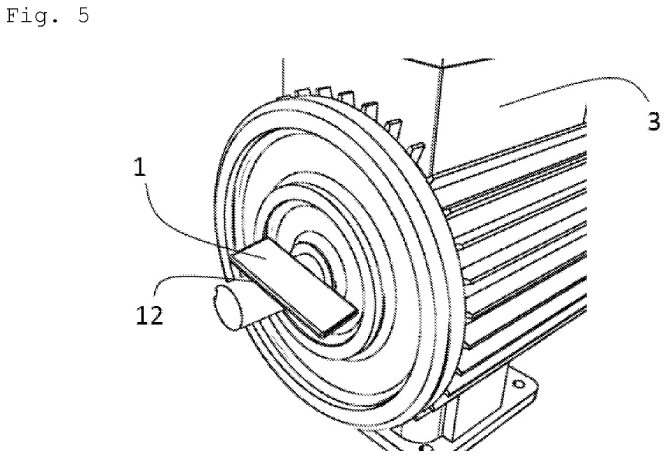

FIG. 5 shows a smartphone 1 acquiring images or videos of the motor axle via sensor 12 to determine the RPM of the motor 3.

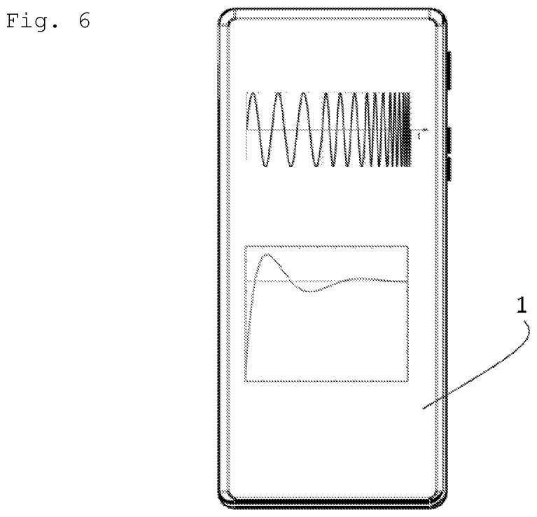

FIG. 6 shows a principal example of the app 6 running on the smartphone 1 while a frequency sweep of the motor speed is performed (upper graph), and an amplitude and step response is measured (lower graph). The shown examples of graphs and measured data may not be limited to be displayed on the smartphone 1 but may also be shown on say a display in the drive 2 and/or on devices such as PC, laptops, tablets, smartphones accessing the cloud.

While the present disclosure has been illustrated and described with respect to a particular embodiment thereof, it should be appreciated by those of ordinary skill in the art that various modifications to this disclosure may be made without departing from the spirit and scope of the present disclosure.

1. A method for commissioning an electric motor drive application, wherein the drive application comprises an electric motor drive and an electric motor, the method comprising the steps of:
performing a measurement at or near the drive application by means of a smart-phone;
transferring the measured data from the smartphone to the drive; and
adjusting the settings of the drive in dependence on the measured data.

2. The method according to claim 1, wherein the method comprises utilising at least one integrated sensor of the smart-phone and in particular only utilising at least one integrated sensor of the smartphone, wherein the sensor is a gyroscope, a microphone, a magnetometer, and or a GPS sensor.

3. The method according to claim 1, wherein a wireless connection is established between the smartphone and the drive.

4. The method according to claim 1, wherein the measured data is pre-processed in the smartphone prior to its transfer to the drive, and or that the smartphone and the drive are time-synchronized.

5. The method according to claim 1, wherein performing the measurement comprises measuring the air pressure and/or air flow speed at the drive application, in particular by using a barometer and/or an anemometer of the smartphone and/or connected to the smartphone.

6. The method according to claim 1, wherein performing the measurement comprises measuring the acceleration of the electric motor and/or of mechanical components connected to the electric motor, in particular by using an accelerometer of the smartphone.

7. The method according to claim 1, wherein performing the measurement comprises determining the number of pole-pairs of the motor, in particular by using a slow-motion camera or a magnetometer of the smartphone.

8. The method according to claim 1, wherein performing the measurement comprises identifying resonances in the application, in particular by using an accelerometer of the smartphone.

9. The method according to claim 1, wherein adjusting the settings of the drive comprises optimizing the drive by means of dedicated algorithms.

10. An electric motor drive, comprising wireless connection means for connecting the drive to a smartphone, wherein the drive is provided for performing the method according to claim 1.

11. The method according to claim 2, wherein a wireless connection is established between the smartphone and the drive.

12. The method according to claim 2, wherein the measured data is pre-processed in the smartphone prior to its transfer to the drive, and or that the smartphone and the drive are time-synchronized.

13. The method according to claim 3, wherein the measured data is pre-processed in the smartphone prior to its transfer to the drive, and or that the smartphone and the drive are time-synchronized.

14. The method according to claim 2, wherein performing the measurement comprises measuring the air pressure and/or air flow speed at the drive application, in particular by using a barometer and/or an anemometer of the smartphone and/or connected to the smartphone.

15. The method according to claim 3, wherein performing the measurement comprises measuring the air pressure and/or air flow speed at the drive application, in particular by using a barometer and/or an anemometer of the smartphone and/or connected to the smartphone.

16. The method according to claim 4, wherein performing the measurement comprises measuring the air pressure and/or air flow speed at the drive application, in particular by using a barometer and/or an anemometer of the smartphone and/or connected to the smartphone.

17. The method according to claim 2, wherein performing the measurement comprises measuring the acceleration of the electric motor and/or of mechanical components connected to the electric motor, in particular by using an accelerometer of the smartphone.

18. The method according to claim 3, wherein performing the measurement comprises measuring the acceleration of the electric motor and/or of mechanical components connected to the electric motor, in particular by using an accelerometer of the smartphone.

19. The method according to claim 4, wherein performing the measurement comprises measuring the acceleration of the electric motor and/or of mechanical components connected to the electric motor, in particular by using an accelerometer of the smartphone.

20. The method according to claim 5, wherein performing the measurement comprises measuring the acceleration of the electric motor and/or of mechanical components connected to the electric motor, in particular by using an accelerometer of the smartphone.
